(19) United States
(12) Patent Application Publication
(10) Pub. No.: US 2024/0345320 A1
(43) Pub. Date: Oct. 17, 2024

(54) TEMPERATURE ADJUSTMENT ELEMENT CONFIGURED TO IMPROVE MODULATION EFFICIENCY

(71) Applicant: Taiwan Semiconductor Manufacturing Company, Ltd., Hsinchu (TW)

(72) Inventors: Wei-Kang Liu, Taichung City (TW); Hau-Yan Lu, Hsinchu City (TW); Yingkit Felix Tsui, Cupertino, CA (US)

(21) Appl. No.: 18/300,575

(22) Filed: Apr. 14, 2023

(51) Int. Cl. G02B 6/125; G02B 6/134

(52) U.S. Cl. CPC G02B 6/125; G02B 6/1347; G02B 2006/12135; G02B 2006/12142

(57) ABSTRACT

Various embodiments of the present disclosure are directed towards a photonic device including a temperature adjustment element. A first waveguide overlies an insulating layer. A second waveguide overlies the insulating layer. The temperature adjustment element includes a heater structure aligned with a segment of the first waveguide and a cooler structure aligned with a segment of the second waveguide. The heater structure is configured to increase a temperature of the segment of the first waveguide to a first temperature. The cooler structure is configured to reduce a temperature of the segment of the second waveguide to a second temperature less than the first temperature.

### BACKGROUND

Optical circuits may comprise multiple photonic functions/devices and optical waveguides. The optical waveguides are configured to confine and guide light from a first point on an integrated chip (IC) to a second point on the IC with minimal attenuation. A photonic device may be configured to selectively change the phase, wavelength, frequency, and/or other properties of light that passes through the optical waveguides.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates a schematic view of some embodiments of a photonic device comprising a temperature adjustment element over a first waveguide and a second waveguide.

FIGS. 2A-2C illustrate various views of some additional embodiments of a photonic device comprising a temperature adjustment element.

FIGS. 3A-3C illustrate various views of some other embodiments of a photonic device comprising a temperature adjustment element.

FIGS. 4A-4C illustrate various views of some additional embodiments of a photonic device comprising a temperature adjustment element.

FIG. 5 illustrates a top view of some embodiments of a photonic device comprising a first temperature adjustment element over a first region of a first waveguide and a second temperature adjustment element over a second region of the first waveguide.

FIGS. 6A-6C through 10A-10C illustrate various views of some embodiments of a method for forming a photonic device comprising a temperature adjustment element over a first waveguide and a second waveguide.

FIG. 11 illustrates a flow diagram of some embodiments of a method for forming a photonic device comprising a temperature adjustment element over a first waveguide and a second waveguide.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Photonic devices may be utilized in integrated chips for many applications including communication, information processing, optical computing, etc. The photonic devices may use light waves (e.g., produced by lasers or light sources) for data processing, data storage, and/or data communication. A photonic device may include a Mach-Zehnder modulator (MZM) structure configured to modulate an input optical signal. The MZM structure comprises a first waveguide and a second waveguide configured to respectively receive first and second optical signals from a beam splitter. During operation of the photonic device, the input optical signal is received at an input terminal with an initial phase, and is then split at the beam splitter to pass along the first and second waveguides before being recombined at a beam combiner and provided as an output optical signal at an output terminal. The output optical signal can be phase shifted due to phase shift(s) introduced along the first waveguide and/or the second waveguide.

A heater structure may be arranged over the first waveguide to generate and apply heat to the first waveguide. This heat can induce a change in temperature of the first waveguide, which in turn changes the refractive index, carrier mobility, and/or other characteristics of the first waveguide relative to that of the second waveguide. Thus, a phase of first optical signal traveling through the first waveguide can be shifted relative to a phase of the second optical signal traveling through the second waveguide. Accordingly, heat generated by the heater structure can control a phase shift imparted to the output optical signal at the output terminal. The heater structure may tune performance of the first waveguide to mitigate variations in optical output powers due to fabrication process variations, performance variation from temperature sensitivity, or the like. However, heat generated by the heater structure is configured to adjust temperature of a single waveguide in the MZM, thereby reducing an ability to tune performance of the second waveguide. In addition, to increase a temperature difference between the first and second waveguides (and thus increase a phase shift difference between the first and second waveguides), relatively high currents may be applied to the heater structure to generate higher heat at the first waveguide. This increases a power consumption of the MZM structure and the higher heat may reduce stability and/or endurance of the photonic device (e.g., through device breakdown, delamination of layers, etc.).

Various embodiments of the present application are directed towards a photonic device including a temperature adjustment element having a heater structure aligned with a segment of a first waveguide and a cooler structure aligned with a second waveguide. In some embodiments, the first waveguide and the second waveguide are respectively configured to receive first and second optical signals from a beam splitter. The heater structure is configured to increase a temperature of the segment of the first waveguide to a first temperature. The cooler structure is configured to decrease a temperature of the segment of the second waveguide to a second temperature less than the first temperature. Accordingly, the heater structure and the cooler structure are configured to selectively introduce phase shifts into the segments of the first and second waveguides by respectively increasing or decreasing temperatures of the first and second waveguides. Because the temperature adjustment elements comprises both the cooler structure and the heater structure, a temperature difference between the first and second waveguides may be increased and/or more precisely controlled. This facilitates increased control of a phase shift of an output optical signal and increases a modulation efficiency of the photonic device.

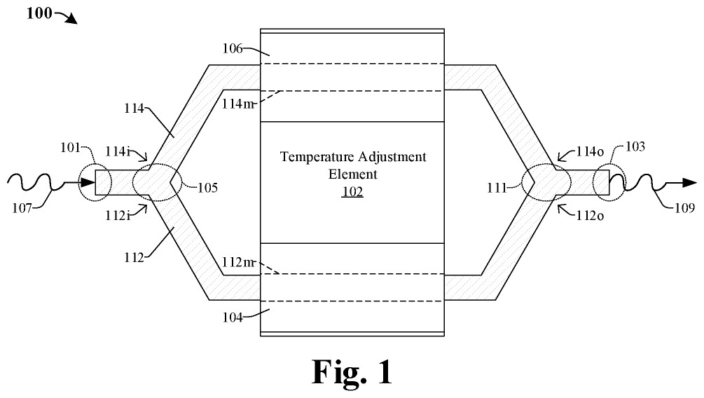

FIG. 1 illustrates a schematic view 100 of some embodiments of a photonic device comprising a temperature adjustment element over a first waveguide and a second waveguide.

The photonic device includes a Mach-Zehnder modulator (MZM) structure having an input terminal 101, an output terminal 103, and first and second waveguides 112, 114 disposed between the input terminal 101 and the output terminal 103. The first waveguide 112 and the second waveguide 114 branch off from the input terminal 101 at a beam splitter 105 and then recombine at a beam combiner 111 before the output terminal 103. In some embodiments, the first and second waveguides 112, 114 branch off symmetrically between the input terminal 101 and the output terminal 103. The first waveguide 112 may be in close proximity to or in direct contact with the second waveguide 114, such that the first and second waveguides 112, 114 are optically coupled to one another. In some embodiments, the first waveguide 112 has a first input region 112i coupled to the input terminal 101 and a first output region 1120 coupled to the output terminal 103. Further, the second waveguide 114 has a second input region 114i coupled to the input terminal 101 and a second output region 1140 coupled to the output terminal 103. In various embodiments, the first waveguide 112 has a first modulation region 112m disposed between the input and output terminals 101, 103 and the second waveguide 114 has a second modulation region 114m disposed between the input and output terminals 101, 103. The input terminal 101 is configured to receive an input optical signal 107. In some embodiments, the beam splitter 105 is configured to split the input optical signal 107 into a first optical signal that is provided to the first waveguide 112 and a second optical signal that is provided to the second waveguide 114.

The photonic device further includes a temperature adjustment element 102 having a heater structure 104 aligned with the first modulation region 112m of the first waveguide 112 and a cooler structure 106 aligned with the second modulation region 114m of the second waveguide 114. The temperature adjustment element 102 is configured to selectively adjust temperatures of the first modulation region 112m and the second modulation region 114m based on a temperature control signal. For instance, the heater structure 104 is configured to increase a temperature of the first modulation region 112m to a first temperature and the cooler structure 106 is configured to decrease a temperature of the second modulation region 114m to a second temperature less than the first temperature. Accordingly, the heater structure 104 and the cooler structure 106 are configured to selectively introduce phase shifts into the first and second modulation regions 112m, 114m of the first and second waveguides 112, 114 by increasing or decreasing temperatures of the first and second modulation regions 112m, 114m. In various embodiments, the temperature adjustment element 102 is configured as a Peltier device or some other suitable temperature adjustment device and may transfer temperature (or heat) from the cooler structure 106 to the heater structure 104. As a result, a temperature of the cooler structure 106 may be less than an ambient temperature (e.g., room temperature) and a temperature of the heater structure 104 may be greater than the ambient temperature (e.g., room temperature).

In some embodiments, during operation of the photonic device, the input optical signal 107 is received at the input terminal 101 with an initial phase, and is then split at the beam splitter 105 into first and second optical signals respectively passed along the first and second waveguides 112, 114. The first and second optical signals are recombined at the beam combiner 111 and provided as an output optical signal 109 at the output terminal 103. Because the temperature adjustment element 102 comprises the heater structure 104 and the cooler structure 106, a temperature difference between the first and second waveguides 112, 114 may be increased and/or more precisely controlled. This facilitates accurately introducing a first phase shift in the first optical signal along the first waveguide 112 and a second phase shift in the second optical signal along the second waveguide 114. The collective effect of the first and second phase shifts along the first waveguide 112 and the second waveguide 114 facilitates the output optical signal 109 having an output phase different from the initial phase of the input optical signal 107. By virtue of the temperature adjustment element 102 facilitating both heating and cooling, a range of phase shift values introduced across the MZM structure may be increased compared to a device that solely comprises a heater. As a result, the output phase of the output optical signal 109 may be more precisely controlled. Accordingly, undesired variations in the output optical signal 109 due to fabrication process variations and/or performance variation from temperature sensitivity may be decreased. Thus, a control of the phase and/or wavelength of optical signals through the first and second waveguides 112, 114 can be improved and a modulation efficiency of the photonic device is increased.

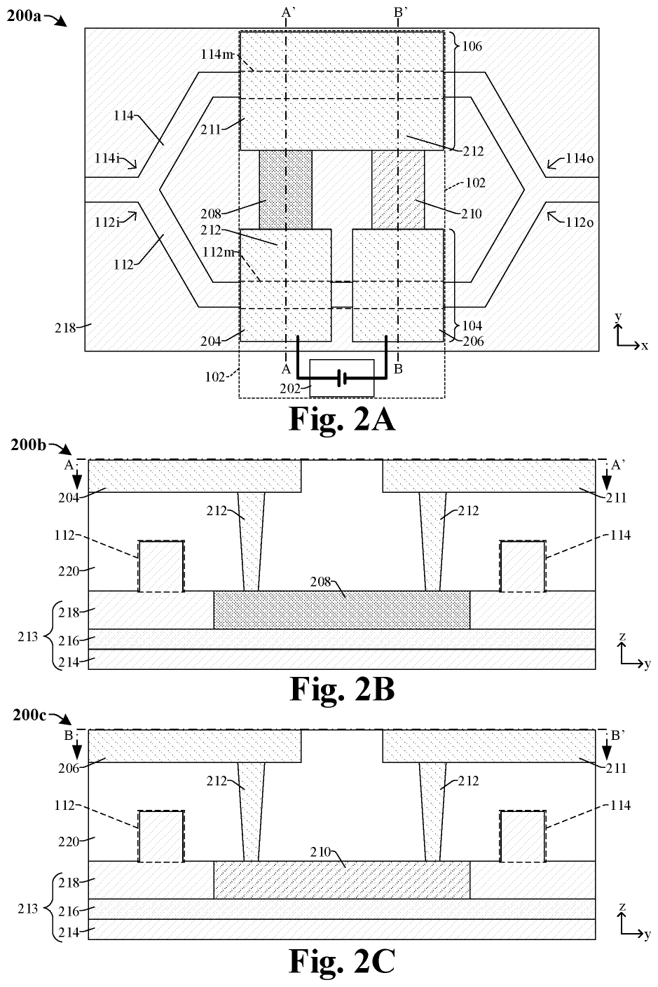

FIGS. 2A-2C illustrate various views of some embodiments of a photonic device comprising a temperature adjustment element over a first waveguide and a second waveguide. FIG. 2A illustrates a top view 200a of some embodiments of the photonic device. FIG. 2B illustrates a cross-sectional view 200b of some embodiments of the photonic device taken along line A-A′ of FIG. 2A. FIG. 2C illustrates a cross-sectional view 200c of some embodiments of the photonic device taken along line B-B′ of FIG. 2A.

As illustrated in the top view 200a of FIG. 2A, the temperature adjustment element 102 comprises a heater structure 104, a cooler structure 106, a first thermoelectric structure 208, a second thermoelectric structure 210, and a plurality of contacts 212. In some embodiments, the heater structure 104 comprises a first conductive heater structure 204 directly overlying a first side of a first modulation region 112m of the first waveguide 112 and a second conductive heater structure 206 directly overlying a second side of the first modulation region 112m. The first conductive heater structure 204 is laterally offset from the second conductive heater structure 206 by a non-zero distance. In various embodiments, the cooler structure 106 comprises a conductive cooler structure 211 directly overlying a second modulation region 114m of the second waveguide 114.

The first and second modulation regions 112m, 114m of the first and second waveguides 112, 114 are respectively elongated in a first direction (e.g., along an x-axis). In some embodiments, the first and second thermoelectric structures 208, 210 are respectively elongated in a second direction (e.g., along a y-axis) different from the first direction. The first and second thermoelectric structures 208, 210 are spaced laterally between the first and second modulation regions 112m, 114m of the first and second waveguides 112, 114. The plurality of contacts 212 are disposed between the first and second thermoelectric structures 208, 210 and the heater and cooler structures 104, 106. The plurality of contacts 212 are configured to electrically and/or thermally couple the first and second thermoelectric structures 208, 210 and the heater and cooler structures 104, 106 to one another (e.g., see FIGS. 2B and 2C). In various embodiments, the first thermoelectric structure 208 is electrically coupled in series between the first conductive heater structure 204 and the conductive cooler structure 211. In yet further embodiments, the second thermoelectric structure 210 is electrically coupled in series between the second conductive heater structure 206 and the conductive cooler structure 211.

In some embodiments, the first thermoelectric structure 208 comprises a semiconductor material (e.g., silicon) having a first doping (e.g., n-type) and the second thermoelectric structure 210 comprises the semiconductor material having a second doping type (e.g., p-type) opposite the first doping type. In some instances, the first doping type is n-type and the second doping type is p-type, or vice versa. By virtue of the first and second thermoelectric structures 208, 210 having opposite doping types, the first thermoelectric structure 208 comprises a high density of first charge carriers (e.g., electrons) and the second thermoelectric structure 210 comprises a high density of second charge carrier (e.g., holes) different from the first charge carriers.

In some embodiments, the temperature adjustment element 102 further comprises a temperature adjustment circuit 202. The temperature adjustment element 102 is electrically coupled to the first and second conductive heater structures 204, 206. In various embodiments, during operation of the photonic device, the temperature adjustment circuit 202 is configured to apply a temperature adjustment signal (e.g., voltage) across the first and second conductive heater structures 204, 206. In response to the applied temperature adjustment signal, the temperature adjustment element 102 is configured to transfer heat or temperature from the conductive cooler structure 211 to the first conductive heater structure 204 and/or to the second conductive heater structure 206. As a result, at least the first modulation region 112m of the first waveguide 112 is heated to a first temperature and at least the second modulation region 114m of the second waveguide 114 is cooled to a second temperature less than the first temperature. In various embodiments, the temperature adjustment element 102 is configured to generate a difference in temperature between the first modulation region 112m and the second modulation region 114m that is within a range of about 1 to 14 degrees Celsius, at least 13 degrees Celsius, greater than 13 degrees Celsius, or some other suitable value.

In various embodiments, the temperature adjustment element 102 may achieve heating of the first modulation region 112m and cooling of the second modulation region 114m through the Peltier effect. For example, upon application of a suitable temperature adjustment signal (e.g., a voltage), current may flow from the first conductive heater structure 204, across the first thermoelectric structure 208, the conductive cooler structure 211, and the second thermoelectric structure 210 to the second conductive heater structure 206. In various embodiments, first charge carriers may travel from the conductive cooler structure 211 and/or the first thermoelectric structure 208 to the first conductive heater structure 204 and second charge carriers may travel from the conductive cooler structure 211 and/or the second thermoelectric structure 210. As the first and/or second charge carriers travel to the first and/or second conductive heater structures 204, 206, heat may be transferred with the charge carriers. Accordingly, heat may be transferred from the conductive cooler structure 211 to first and/or second conductive heater structures 204, 206. The change in temperature at or around the first and second modulation regions 112m. 114m may change the refractive indices of the first and second waveguides 112, 114, thereby introducing a first phase change along the first waveguide 112 and a second phase change along the second waveguide 114. In various embodiments, by heating the first modulation region 112m the first phase change may be positive and by cooling the second modulation region 114m the second phase change may be negative. Therefore, because the temperature adjustment element 102 comprises the heater structure 104, the cooler structure 106, and the first and second thermoelectric structures 208, 210, phase shift(s) across the first and second waveguides 112, 114 may be more precisely controlled. This, in part, facilitates increased control of a phase shift of an output optical signal and increases a modulation efficiency of the photonic device.

As illustrated in the cross-sectional view 200b of FIG. 2B, the first and second waveguides 112, 114 are disposed on and/or within a substrate 213. In some embodiments, the substrate 213 is configured as a semiconductor-on-insulator (SOI) substrate. In such embodiments, the substrate 213 comprises a lower substrate 214 separated from an active layer 218 by an insulating layer 216. The insulating layer 216 may, for example, be or comprise an oxide (e.g., silicon dioxide), another dielectric material, or the like. The active layer 218 may, for example, be or comprise silicon, monocrystalline silicon, intrinsic silicon, bulk silicon, another suitable semiconductor material, or the like. The first and second waveguides 112, 114 respectively comprise a protrusion or a fin extending upward from an upper surface of the active layer 218. In such embodiments, the first and second waveguides 112, 114 respectively comprise a semiconductor material (e.g., silicon). In various embodiments, the first and second waveguides 112, 114 may respectively be configured as a strip loaded waveguide, a ridge waveguide, a rib waveguide, or the like.

A dielectric structure 220 overlies the substrate 213. The dielectric structure 220 comprises one or more dielectric layers. In some embodiments, the dielectric structure 220 comprises silicon dioxide, borophosphate silicate glass (BSG), phosphosilicate glass (PSG), borophosphosilicate glass (BPSG), fluorosilicate glass (FSG), undoped silicate glass (USG), some other suitable dielectric material, or any combination of the foregoing. In yet further embodiments, the dielectric structure 220 is or comprises a cladding layer disposed on top of or around the first and second waveguides 112, 114, where the cladding layer comprises a material (e.g., silicon dioxide) having a refractive index lower than a refractive index of the first and second waveguides 112, 114.

In some embodiments, the first thermoelectric structure 208 is disposed within the substrate 213 and is spaced laterally between the first and second waveguides 112, 114. In further embodiments, the second thermoelectric structure 210 is disposed within the substrate 213 and is spaced laterally between the first and second waveguides 112, 114 (e.g., see FIG. 2C). In various embodiments, the first and second thermoelectric structures 208, 210 are doped regions of the active layer 218 and respectively comprise a semiconductor material (e.g., silicon) having opposite doping types. Further, contacts 212 are disposed within the dielectric structure 220 and are configured to electrically couple the first thermoelectric structure 208 to the first conductive heater structure 204 and the conductive cooler structure 211. In various embodiments, at least a portion of the first conductive heater structure 204 directly overlies a first side of the first thermoelectric structure 208 and at least a portion of the conductive cooler structure 211 directly overlies a second side of the first thermoelectric structure 208. Accordingly, in some embodiments, heat at or around the conductive cooler structure 211 may be transferred from an area or region around the second waveguide 114 through the contacts 212 and the first thermoelectric structure 208 to the first conductive heater structure 204.

As illustrated in the cross-sectional view 200c of FIG. 2C, contacts 212 are disposed within the dielectric structure 220 and are configured to electrically couple the second thermoelectric structure 210 to the second conductive heater structure 206 and the conductive cooler structure 211. In various embodiments, at least a portion of the second conductive heater structure 206 directly overlies a first side of the second thermoelectric structure 210 and at least a portion of the conductive cooler structure 211 directly overlies a second side of the second thermoelectric structure 210. Accordingly, in some embodiments, heat at or around the conductive cooler structure 211 may be transferred from an area or region around the second waveguide 114 through the contacts and the second thermoelectric structure 210 to the second conductive heater structure 206.

The contacts 212 may, for example, be or comprise copper, aluminum, tungsten, some other conductive material, or the like. The first conductive heater structure 204, the second conductive heater structure 206, and the conductive cooler structure 211 may, for example, be or comprise copper, aluminum, tungsten, some other conductive material, or the like. In some embodiments, the first and/or second thermoelectric structures 208, 210 may respectively be or comprise a thermoelectric material, such as silicon, bismuth telluride (Bi₂Te₃), palladium telluride (PdTe), some other suitable material, or the like.

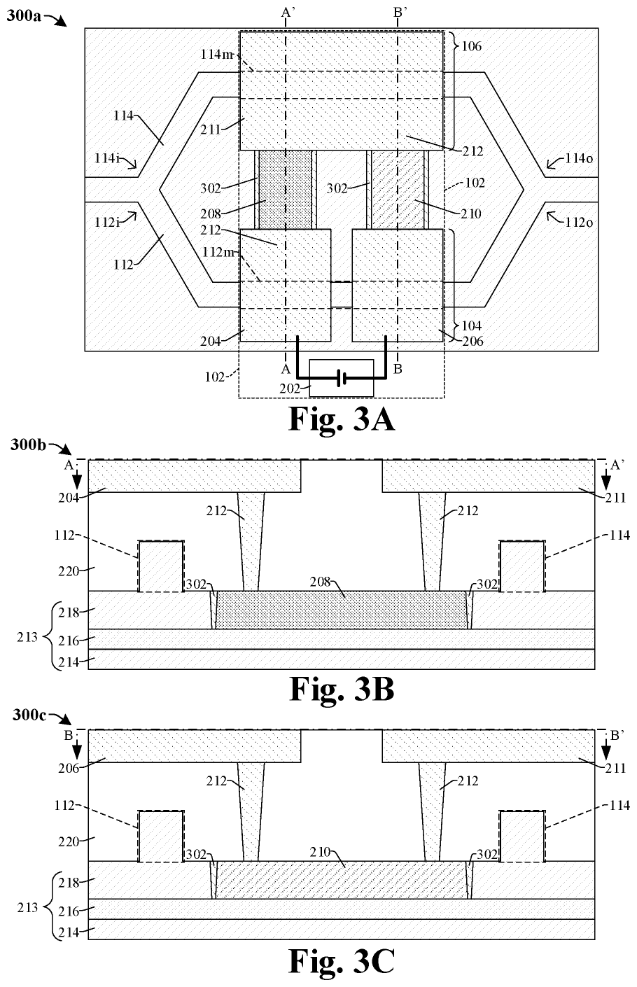

FIGS. 3A-3C illustrate various views of some embodiments of a photonic device corresponding to some other embodiments of the photonic device of FIGS. 2A-2C, in which an isolation structure 302 laterally encloses each of the first and second thermoelectric structures 208, 210. FIG. 3A illustrates a top view 300a of some embodiments of the photonic device. FIG. 3B illustrates a cross-sectional view 300b of some embodiments of the photonic device taken along line A-A′ of FIG. 3A. FIG. 3C illustrates a cross-sectional view 300c of some embodiments of the photonic device taken along line B-B′ of FIG. 3A.

In various embodiments, the isolation structure 302 is configured as a shallow trench isolation (STI) structure configured to electrically isolate the first and second thermoelectric structures 208, 210 from other devices or structures (e.g., the first and second waveguides 112, 114) disposed within and/or on the substrate 213. The isolation structure 302 may, for example, be or comprise silicon dioxide, silicon nitride, silicon oxynitride, silicon oxycarbide, some other suitable material, or any combination of the foregoing. In further embodiments, the isolation structure 302 may continuously vertically extend from an upper surface of the active layer 218 to a bottom surface of the active layer 218.

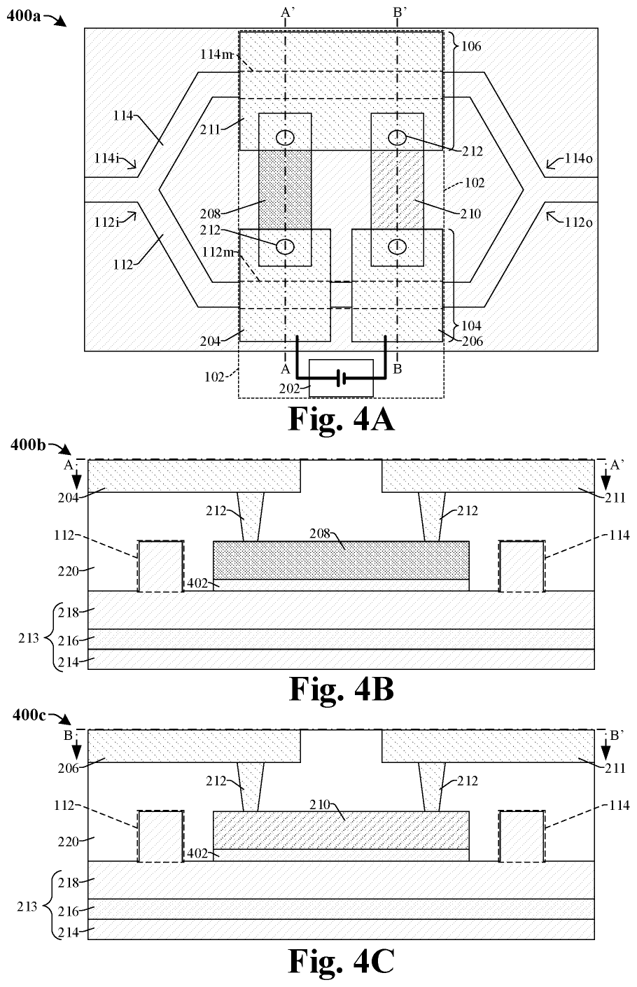

FIGS. 4A-4C illustrate various views of some embodiments of a photonic device corresponding to some other embodiments of the photonic device of FIGS. 2A-2C, in which the first and second thermoelectric structures 208, 210 directly overlie the upper surface of the substrate 213. FIG. 4A illustrates a top view 400a of some embodiments of the photonic device. FIG. 4B illustrates a cross-sectional view 400b of some embodiments of the photonic device taken along line A-A′ of FIG. 4A. FIG. 4C illustrates a cross-sectional view 400c of some embodiments of the photonic device taken along line B-B′ of FIG. 4A.

In some embodiments, a dielectric layer 402 is disposed between the upper surface of the substrate 213 and the first and second thermoelectric structures 208, 210. In some embodiments, the first and/or second thermoelectric structures 208, 210 respectively comprise a thermoelectric material, such as silicon, bismuth telluride (Bi₂Te₃), palladium telluride (PdTe), some other suitable material, or the like. In yet further embodiments, the first thermoelectric structure 208 has a first doping type (e.g., n-type) and the second thermoelectric structure 210 has a second doping type (e.g., p-type) opposite the first doping type. By virtue of the first and second thermoelectric structures 208, 210 being disposed over the upper surface of the substrate 213, isolation between the first and second thermoelectric structures 208, 210 and the first and/or second waveguides 112, 114 may be increased. As a result, an overall performance of the photonic device is increased. In yet further embodiments, the dielectric layer 402 may be omitted (not shown) such that the first and second thermoelectric structures 208, 210 directly contact the upper surface of the substrate 213.

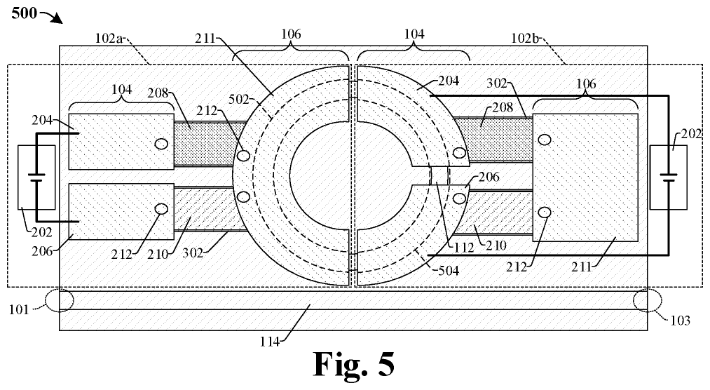

FIG. 5 illustrates a top view 500 of some embodiments of a photonic device comprising a first temperature adjustment element 102a over a first segment 502 of a first waveguide 112 and a second temperature adjustment element 102b over a second segment 504 of the first waveguide 112.

In some embodiments, when viewed from above the first waveguide 112 has a ring-like shape and the second waveguide 114 has a rectangular shape. In yet further embodiments, the second waveguide 114 comprises some curved portions (not shown). The second waveguide 114 is configured to confine an optical signal from the input terminal 101 to the output terminal 103. The second waveguide 114 is arranged close enough to the first waveguide 112, such that the first and second waveguides 112, 114 are optically coupled to one another. In various embodiments, an input optical signal received at the input terminal 101 may be carried across the second waveguide 114 and may be transmitted to the first waveguide 112. As the input optical signal travels through the first waveguide 112, the input optical signal may be modulated (e.g., by a phase shift introduced across the first waveguide 112), and subsequently transferred back to the second waveguide 114 to be output as an output optical signal at the output terminal 103. In various embodiments, the first and second waveguides 112, 114 may respectively be configured as a strip loaded waveguide, a ridge waveguide, a rib waveguide, or the like.

The photonic device comprises a first temperature adjustment element 102a and a second temperature adjustment element 102b. The first and second temperature adjustment elements 102a, 102b respectively comprise a heater structure 104, a cooler structure 106, a first thermoelectric structure 208, a second thermoelectric structure 210, a plurality of contacts 212, and a temperature adjustment circuit 202. The first and second temperature adjustment elements 102a. 102b may respectively be configured as illustrated and/or described in FIGS. 2A-2C, 3A-3C, or 4A-4C. In various embodiments, the cooler structure 106 of the first temperature adjustment element 102a overlies the first segment 502 of the first waveguide 112 and the heater structure 104 of the second temperature adjustment element 102b overlies the second segment 504 of the first waveguide 112. In some embodiments, the first and/or second temperature adjustment elements 102a, 102b are configured to introduce one or more phase shifts in an optical signal passing through the first waveguide 112.

The first temperature adjustment element 102a is configured to selectively reduce a temperature of the first segment 502 of the first waveguide 112 and the second temperature adjustment element 102b is configured to selectively increase a temperature of the second segment 504 of the first waveguide 112. For instance, through suitable application of a first temperature control signal by the temperature adjustment circuit 202 of the first temperature adjustment element 102a, heat at or around the cooler structure 106 of the first temperature adjustment element 102a may be transferred to the heater structure 104 of the first temperature adjustment element 102a. Thus, the first segment 502 of the first waveguide 112 may be selectively cooled. Further, in such embodiments, the heater structure 104 of the first temperature adjustment element 102a is laterally offset from the first and second waveguides 112, 114 such that the accumulated heat at the heater structure 104 of the first temperature adjustment element 102a has minimal or no heating effect on the first and second waveguides 112, 114. Furthermore, through suitable application of a second temperature control signal by the temperature adjustment circuit 202 of the second temperature adjustment element 102b, heat at or around the cooler structure 106 of the second temperature adjustment element 102b may be transferred to the heater structure 104 of the second temperature adjustment element 102b. Thus, the second segment 504 of the first waveguide 112 may be selectively heated. In such embodiments, the cooler structure 106 of the second temperature adjustment element 102b is laterally offset from the first and second waveguides 112, 114 such that a reduction in temperature at the cooler structure 106 of the second temperature adjustment element 102b has minimal or no cooling effect on the first and second waveguides 112, 114.

The ring-shaped first waveguide 112 and the second waveguide 114 have a resonant frequency at which light (e.g., an optical signal) resonates in the first waveguide 112. The light at the resonant frequency constructively interferes and passes to an output of the second waveguide 114 to be provided at the output terminal 103. However, light offset from the resonant frequency may undergo destructive interference and hence does not pass, or only minimally passes to, the output of the second waveguide 114. Due to processing tool limitations (e.g., due to limitations in photolithography) and/or due to temperature sensitivity, the resonant frequency of the first waveguide 112 may be shifted from a desired resonant frequency during manufacturing and/or operation of the first waveguide 112. In various embodiments, reducing a temperature (or cooling) of a segment of the first waveguide 112 decreases the resonant frequency of the first waveguide 112 and increasing (or heating) a segment of the first waveguide 112 increases the resonant frequency of the first waveguide 112. Because the cooler structure 106 of the first temperature adjustment element 102a and the heater structure 104 of the second temperature adjustment element 102b are respectively disposed over the first and second segments 502, 504 of the first waveguide 112, the resonant frequency of the first waveguide 112 may be selectively adjusted to meet predefined design parameters. For example, the first and second temperature adjustment elements 102a, 102b are configured to work in conjunction with one another to heat and/or cool a corresponding segment of the first waveguide 112 to achieve a desired resonant frequency. As a result, shifts in the resonant frequency of the first waveguide 112 due to fabrication variations and/or temperature sensitivity may be accurately compensated for. Therefore, a modulation efficiency and overall performance of the photonic device are increased.

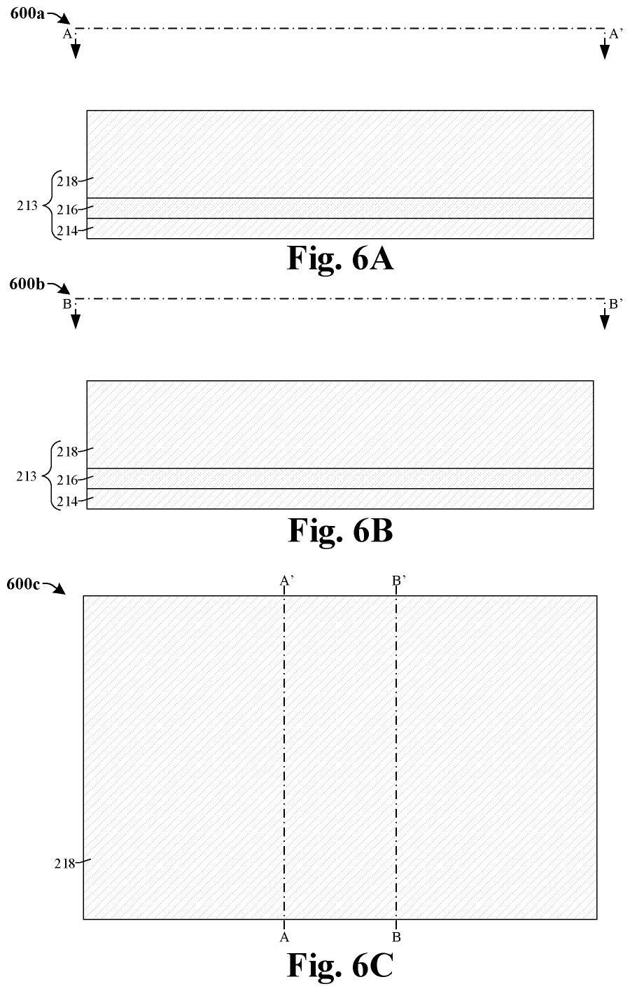

FIGS. 6A-6C through 10A-10C illustrate various views of some embodiments of a method for forming a photonic device comprising a temperature adjustment element over a first waveguide and a second waveguide. Figures with a suffix of “A” and “B” illustrate cross-sectional views of the photonic device during various formation processes. Figures with a suffix of “C” illustrate a top view of the photonic device during various formation processes. For example, figures with a suffix of “A” illustrate a cross-sectional view taken along the line A-A′ of figures with a suffix of “C” and figures with a suffix of “B” illustrate a cross-sectional view taken along the line B-B′ of figures with a suffix of “C.” Although the various views shown in FIGS. 6A-6C through 10A-10C are described with reference to a method of forming the photonic device, it will be appreciated that the structures shown in 6A-6C through 10A-10C are not limited to the method of formation but rather may stand alone as structures independent of the method.

As shown in cross-sectional views 600a and 600b of FIGS. 6A-6B and top view 600c of FIG. 6C, a substrate 213 is provided. In various embodiments, the substrate 213 may, for example, be or comprise intrinsic silicon, bulk silicon, a semiconductor wafer, one or more epitaxial layers, some other semiconductor body, or the like. In some embodiments, the substrate 213 is an SOI substrate comprising a lower substrate 214, an active layer 218, and an insulating layer 216 disposed between the lower substrate 214 and the active layer 218. The active layer 218 may, for example, be or comprise silicon, monocrystalline silicon, epitaxial silicon, some other suitable semiconductor, or the like.

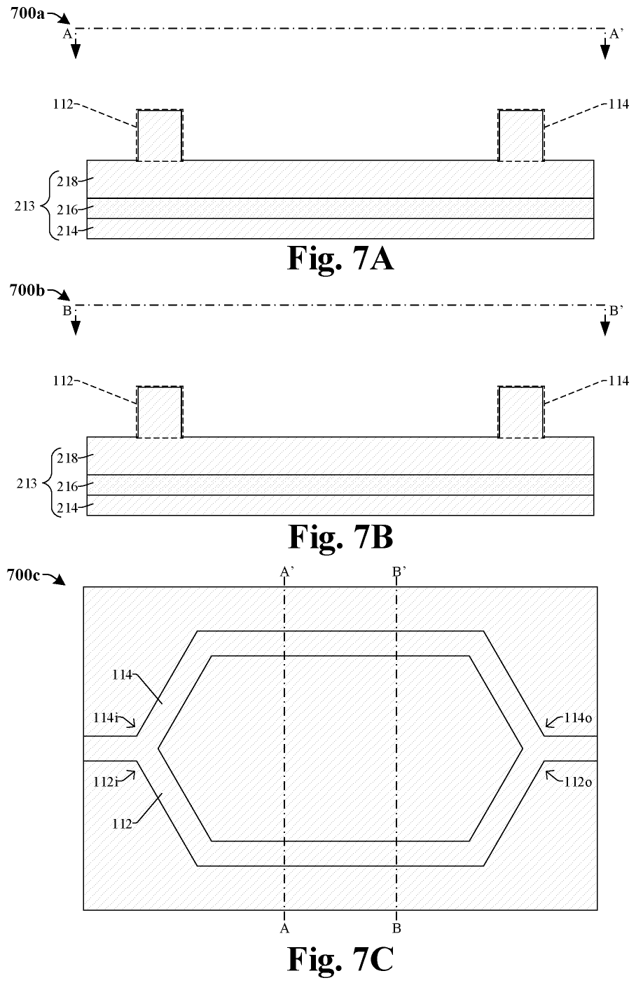

As shown in cross-sectional views 700a and 700b of FIGS. 7A-7B and top view 700c of FIG. 7C, a patterning process is performed on the active layer 218 thereby forming a first waveguide 112 and a second waveguide 114 protruding from an upper surface of the substrate 213. In some embodiments, the patterning process includes forming a masking layer (not shown) over the active layer 218 and performing an etching process on the active layer 218 according to the masking layer. The etching process comprises, for example, a dry etch process (e.g., a plasma etching process, an ion beam etching process, or the like), a wet etch process, some other suitable etching process, or any combination of the foregoing. In some embodiments, the masking layer is removed after and/or during the etching process. In various embodiments, the patterning process forms a Mach-Zehnder modulator (MZM) structure in the active layer 218, where the first and second waveguides 112, 114 are part of the MZM structure (e.g., see FIG. 7C).

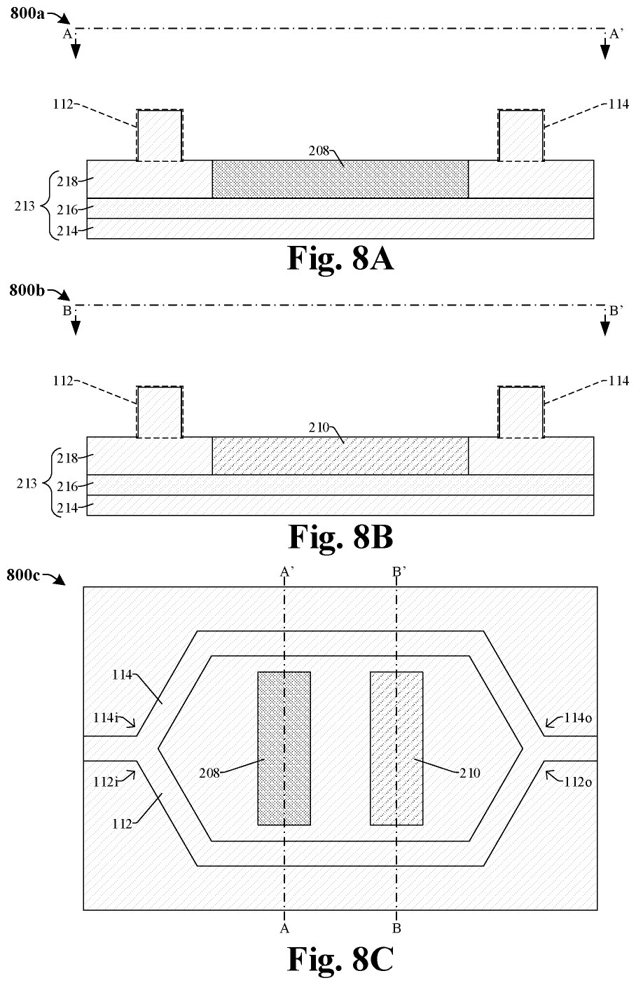

As shown in cross-sectional views 800a and 800b of FIGS. 8A-8B and top view 800c of FIG. 8C, a first thermoelectric structure 208 and a second thermoelectric structure 210 are formed over and/or on the substrate 213. In various embodiments, a process for forming the first and second thermoelectric structures 208, 210 comprises: performing a first ion implantation process to implant first dopant(s) (e.g., phosphorus, antimony, arsenic, some other n-type dopant(s), or any combination of the foregoing) having a first doping type (e.g., n-type) within the active layer 218 (thereby forming the first thermoelectric structure 208); and performing a second ion implantation process to implant second dopant(s) (e.g., boron, gallium, some other p-type dopant(s), or any combination of the foregoing) having a second doping type (e.g., p-type) within the active layer 218 (thereby forming the second thermoelectric structure 210). In some embodiments, the first and second ion implantation processes may respectively comprise forming a masking layer (not shown) over the substrate 213 and implanting corresponding dopants into the active layer 218. In some embodiments, the first thermoelectric structure 208 comprises the first doping type (e.g., n-type) and the second thermoelectric structure 210 comprises the second doping type (e.g., p-type). In further embodiments, an isolation structure (not shown) may be formed around the first and second thermoelectric structures 208, 210 (e.g., as illustrated and/or described in FIGS. 3A-3C). In various embodiments, a first doping concentration of the first dopant(s) in the first thermoelectric structure 208 is within a range of about 10¹⁵ cm⁻³ to 10²¹ cm⁻³ or some other suitable value. In yet further embodiments, a second doping concentration of the second dopant(s) in the second thermoelectric structure 210 is within a range of about 10¹⁵ cm⁻³ to 10²¹ cm⁻³ or some other suitable value.

In yet further embodiments, a process for forming the first and second thermoelectric structures 208, 210 includes: depositing (e.g., by a chemical vapor deposition (CVD) process, a physical vapor deposition (PVD) process, an atomic layer deposition (ALD) process, or some other suitable growth or deposition process) one or more thermoelectric materials over an upper surface of the substrate 213; performing one or more ion implantation processes on the one or more thermoelectric materials; and performing a patterning process on the one or more thermoelectric materials. In such embodiments, the first and second thermoelectric structures 208, 210 may be configured as illustrated and/or described in FIGS. 4A-4C.

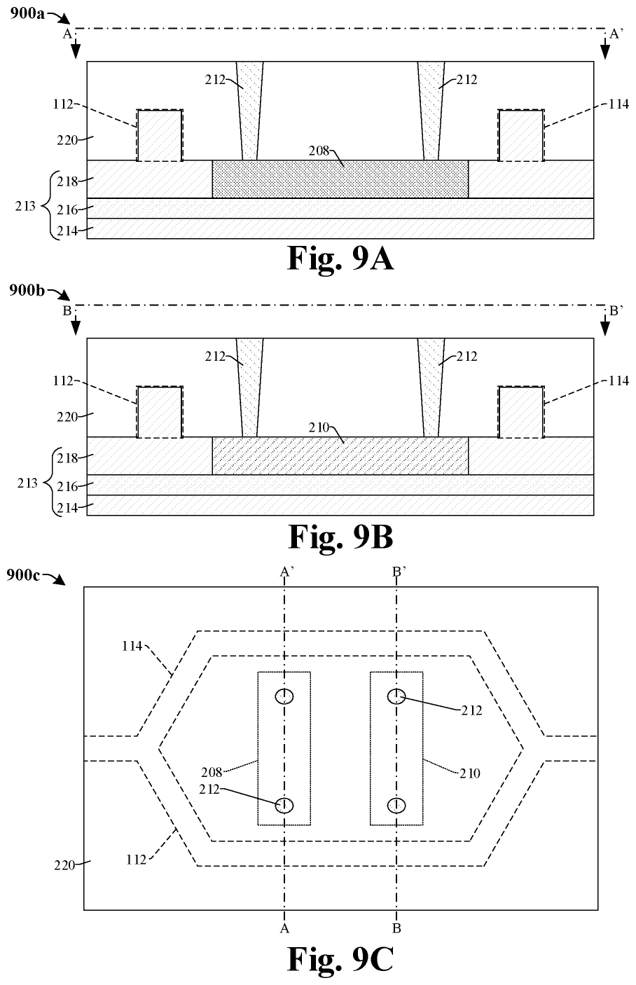

As shown in cross-sectional views 900a and 900b of FIGS. 9A-9B and top view 900c of FIG. 9C, a dielectric structure 220 and a plurality of contacts 212 are formed over the substrate 213. In some embodiments, a process for forming the dielectric structure 220 includes performing one or more depositions process(es) (e.g., CVD process(es), PVD process(es), ALD process(es), or some other suitable growth or deposition process(es)) to deposit one or more dielectric layers over the substrate 213. The one or more dielectric layers of the dielectric structure 220 may, for example, respectively be or comprise silicon dioxide, BSG, PSG, BPSG, FSG, USG, some other suitable dielectric material, or any combination of the foregoing. In yet further embodiments, a process for forming the plurality of contacts 212 includes: forming a masking layer (not shown) over the dielectric structure 220; performing an etching process (e.g., a dry etch process, a wet etch process, etc.) on the dielectric structure 220 according to the masking layer, thereby forming a plurality of contact openings in the dielectric structure 220; depositing (e.g., by a CVD process, a PVD process, sputtering, electroplating, etc.) a conductive material (e.g., tungsten, aluminum, copper, etc.) within the plurality of contact openings. In further embodiments, a planarization process (e.g., a chemical mechanical planarization (CMP) process) is performed into the conductive material.

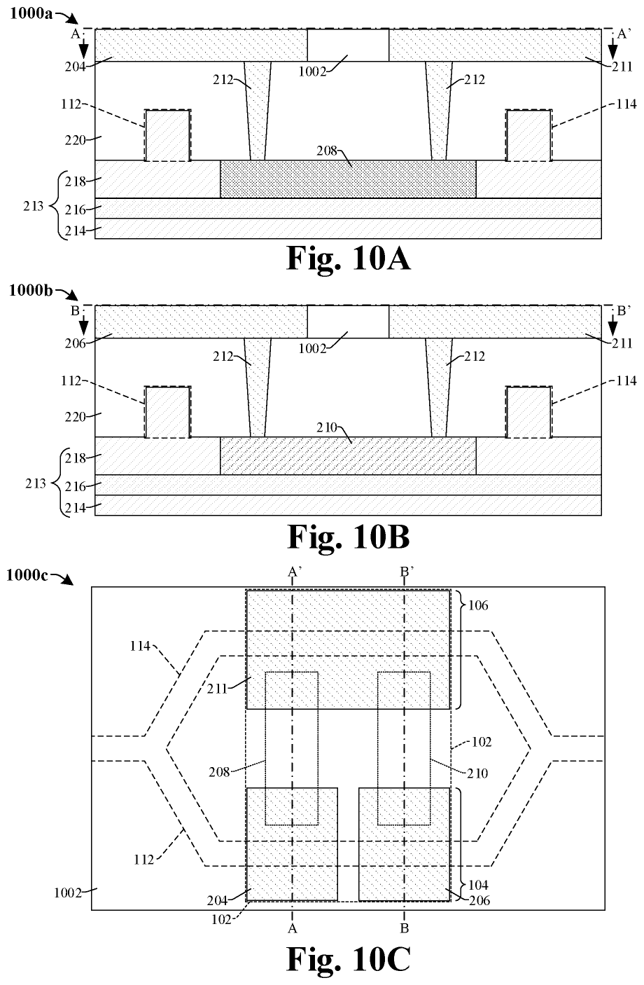

As shown in cross-sectional views 1000a and 1000b of FIGS. 10A-10B and top view 1000c of FIG. 10C, a heater structure 104 is formed over a segment of the first waveguide 112 and a cooler structure 106 is formed over a segment of the second waveguide 114, thereby forming a temperature adjustment element 102. In some embodiments, the heater structure 104 comprises a first conductive heater structure 204 and a second conductive heater structure 206 and the cooler structure 106 comprises a conductive cooler structure 211. In various embodiments, a process for forming the heater and cooler structures 104, 106 comprises: depositing (e.g., by a CVD process, a PVD process, an ALD process, etc.) an upper dielectric layer 1002 over the dielectric structure 220; patterning the upper dielectric layer 1002 to form a plurality of openings in the upper dielectric layer 1002; and depositing (e.g., by a CVD process, a PVD process, sputtering, electroplating, etc.) a conductive material (e.g., tungsten, aluminum, copper, etc.) within the plurality of openings. In further embodiments, a planarization process (e.g., a CMP process) is performed into the conductive material. The upper dielectric layer 1002 may, for example, be or comprise silicon dioxide, BSG, PSG, BPSG, FSG, USG, some other suitable dielectric material, or any combination of the foregoing.

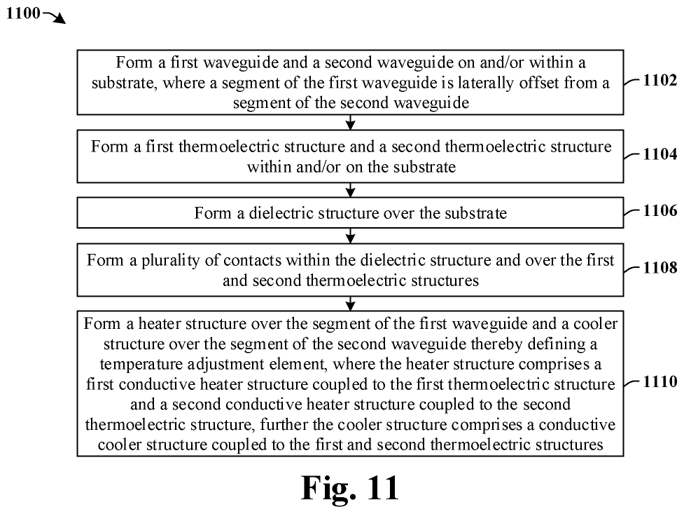

FIG. 11 illustrate a flow diagram of some embodiments of a method 1100 for forming a photonic device comprising a temperature adjustment element over a first waveguide and a second waveguide. Although the method 1100 is illustrated and/or described as a series of acts or events, it will be appreciated that the method is not limited to the illustrated ordering of acts. Thus, in some embodiments, the acts may be carried out in different orders than illustrated, and/or may be carried out concurrently. Further, in some embodiments, the illustrated acts or events may be subdivided into multiple acts or events, which may be carried out at separate times or concurrently with other acts or sub-acts. In some embodiments, some illustrated acts or events may be omitted, and other un-illustrated acts or events may be included.

At act 1102, a first waveguide and a second waveguide are formed on and/or within a substrate, where a segment of the first waveguide is laterally offset from a segment of the second waveguide. FIGS. 7A-7C illustrate various views of some embodiments corresponding to act 1102.

At act 1104, a first thermoelectric structure and a second thermoelectric structure are formed within and/or on the substrate. FIGS. 8A-8C illustrate various views of some embodiments corresponding to act 1104.

At act 1106, a dielectric structure is formed over the substrate. FIGS. 9A-9C illustrate various views of some embodiments corresponding to act 1106.

At act 1108, a plurality of contacts are formed within the dielectric structure and over the first and second thermoelectric structures. FIGS. 9A-9C illustrate various views of some embodiments corresponding to act 1108.

At act 1110, a heater structure is formed over the segment of the first waveguide and a cooler structure is formed over the segment of the second waveguide thereby defining a temperature adjustment structure. The heater structure comprises a first conductive heater structure coupled to the first thermoelectric structure and a second conductive heater structure coupled to the second thermoelectric structure. Further, the cooler structure comprises a conductive cooler structure coupled to the first and second thermoelectric structures. FIGS. 10A-10C illustrate various views of some embodiments corresponding to act 1110.

Accordingly, in some embodiments, the present disclosure relates to a temperature adjustment element comprising a heater structure over a first waveguide and a cooler structure over a second waveguide, where the temperature adjustment element is configured to increase a temperature of the first waveguide and decreases a temperature of the second waveguide.

In some embodiments, the present application provides a photonic device including: an insulating layer; a first waveguide overlying the insulating layer; a second waveguide overlying the insulating layer; and a temperature adjustment element comprising a heater structure aligned with a segment of the first waveguide and a cooler structure aligned with a segment of the second waveguide, wherein the heater structure is configured to increase a temperature of the segment of the first waveguide to a first temperature, wherein the cooler structure is configured to reduce a temperature of the segment of the second waveguide to a second temperature less than the first temperature.

In some embodiments, the present application provides an integrated chip including: a first waveguide segment overlying an insulating layer; a second waveguide segment overlying the insulating layer, wherein the first waveguide segment is laterally separated from the second waveguide segment by a lateral distance; a first conductive heater structure overlying the first waveguide segment; a second conductive heater structure overlying the first waveguide segment and laterally offset from the first conductive heater structure; a first conductive cooler structure overlying the second waveguide segment; a first thermoelectric structure at least partially underlying the first conductive cooler structure; and a second thermoelectric structure laterally offset from the first thermoelectric structure and at least partially underlying the first conductive cooler structure.

In some embodiments, the present application provides a method for forming a photonic device, the method includes: forming a first waveguide on or within a substrate; forming a second waveguide on or within the substrate, wherein a segment of the second waveguide is laterally offset a segment of the first waveguide; forming a first thermoelectric structure on or within the substrate, wherein the first thermoelectric structure has a first doping type; forming a second thermoelectric structure on or within the substrate, wherein the second thermoelectric structure has as second doping type opposite the first doping type; forming a heater structure over the segment of the first waveguide; and forming a cooler structure over the segment of the second waveguide, wherein the first and second thermoelectric structures are electrically coupled between the heater structure and the cooler structure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A photonic device, comprising:
an insulating layer;
a first waveguide overlying the insulating layer;
a second waveguide overlying the insulating layer; and
a temperature adjustment element comprising a heater structure aligned with a segment of the first waveguide and a cooler structure aligned with a segment of the second waveguide, wherein the heater structure is configured to increase a temperature of the segment of the first waveguide to a first temperature, wherein the cooler structure is configured to reduce a temperature of the segment of the second waveguide to a second temperature less than the first temperature.

2. The photonic device of claim 1, wherein the temperature adjustment element is configured to transfer heat from the cooler structure to the heater structure based upon a temperature control signal applied to the heater structure.

3. The photonic device of claim 1, wherein the temperature adjustment element comprises a first thermoelectric structure disposed within a substrate and a second thermoelectric structure adjacent to the first thermoelectric structure, wherein the first and second thermoelectric structures are disposed laterally between the first waveguide and the second waveguide.

4. The photonic device of claim 3, wherein the heater structure comprises a first conductive heater structure overlying a first side of the segment of the first waveguide and a second conductive heater structure overlying a second side of the segment of the first waveguide, wherein the cooler structure comprises a conductive cooler structure overlying the second waveguide, wherein the first thermoelectric structure is coupled between the first conductive heater structure and the conductive cooler structure, and wherein the second thermoelectric structure is electrically coupled between the second conductive heater structure and the conductive cooler structure.

5. The photonic device of claim 4, wherein the first thermoelectric structure comprises a first doping type and the second thermoelectric structure comprises a second doping type opposite the first doping type.

6. The photonic device of claim 4, wherein bottom surfaces of the first and second thermoelectric structures are vertically below the first and second waveguides, and wherein bottom surfaces of the first and second conductive heater structures and the conductive cooler structure are vertically above top surfaces of the first and second waveguides.

7. The photonic device of claim 4, wherein an area of the conductive cooler structure is greater than an area of the first conductive heater structure and an area of the second conductive heater structure.

8. The photonic device of claim 4, wherein the first thermoelectric structure and the second thermoelectric structure respectively comprise a semiconductor material.

9. The photonic device of claim 8, wherein the first waveguide and the second waveguide respectively comprise the semiconductor material.

10. An integrated chip, comprising:
a first waveguide segment overlying an insulating layer;
a second waveguide segment overlying the insulating layer, wherein the first waveguide segment is laterally separated from the second waveguide segment by a lateral distance;
a first conductive heater structure overlying the first waveguide segment;
a second conductive heater structure overlying the first waveguide segment and laterally offset from the first conductive heater structure;
a first conductive cooler structure overlying the second waveguide segment;
a first thermoelectric structure at least partially underlying the first conductive cooler structure; and
a second thermoelectric structure laterally offset from the first thermoelectric structure and at least partially underlying the first conductive cooler structure.

11. The integrated chip of claim 10, wherein the first thermoelectric structure comprises a first doping type and the second thermoelectric structure comprises a second doping type opposite the first doping type.

12. The integrated chip of claim 10, wherein the first and second waveguide segments are part of a ring-shaped waveguide, wherein the first conductive cooler structure is part of a first temperature adjustment element comprising third and fourth conductive heater structures laterally offset from the ring-shaped waveguide, wherein the first and second thermoelectric structures laterally extend from the first conductive cooler structure to the third conductive heater structure or the fourth conductive heater structure.

13. The integrated chip of claim 12, wherein the first and second conductive heater structures are part of a second temperature adjustment element comprising a second conductive cooler structure laterally offset from the ring-shaped waveguide, wherein the second temperature adjustment element further comprises a third thermoelectric structure and a fourth thermoelectric structure at least partially directly underlying the second conductive cooler structure.

14. The integrated chip of claim 12, wherein when viewed from above a shape of the first conductive cooler structure is different from a shape of the third conductive heater structure.

15. The integrated chip of claim 10, wherein the first and second thermoelectric structures respectively comprises silicon, bismuth telluride, or palladium telluride.

16. A method for forming a photonic device, comprising:
forming a first waveguide on or within a substrate;
forming a second waveguide on or within the substrate, wherein a segment of the second waveguide is laterally offset a segment of the first waveguide;
forming a first thermoelectric structure on or within the substrate, wherein the first thermoelectric structure has a first doping type;
forming a second thermoelectric structure on or within the substrate, wherein the second thermoelectric structure has as second doping type opposite the first doping type;
forming a heater structure over the segment of the first waveguide; and
forming a cooler structure over the segment of the second waveguide, wherein the first and second thermoelectric structures are electrically coupled between the heater structure and the cooler structure.

17. The method of claim 16, wherein forming the first and second thermoelectric structures comprises:
performing a first ion implantation process to form the first thermoelectric structure within the substrate; and
performing a second ion implantation process to form the second thermoelectric structure within the substrate, wherein the first and second thermoelectric structures are disposed laterally between the segments of the first and second waveguides.

18. The method of claim 16, wherein forming the first and second thermoelectric structures comprises:
depositing one or more thermoelectric materials over an upper surface of the substrate;
performing one or more ion implantation process on the one or more thermoelectric materials; and
performing a patterning process on the one or more thermoelectric materials.

19. The method of claim 16, further comprising:
forming a plurality of contacts over the first and second thermoelectric structures, wherein the plurality of contacts are disposed vertically between the first and second thermoelectric structures and the heater and cooler structures.

20. The method of claim 16, wherein the heater structure and the cooler structure are formed concurrently with one another.
